(19) United States
(12) Patent Application Publication
(10) Pub. No.: US 2008/0124605 A1
(43) Pub. Date: May 29, 2008

(54) Solid Electrolyte And Manufacturing Method Of The Same

(75) Inventors: Keisuke Nagasaka, Shizuoka-ken (JP); Masahiko Lijima, Saitama-ken (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 11/792,115

(22) PCT Filed: Nov. 28, 2005
(86) PCT No.: PCT/JP05/22223

§ 371 Date: Jun. 1, 2007

(30) Foreign Application Priority Data
Dec. 8, 2004 (JP) 2004-355872

(51) Int. Cl. H01M 8/10; C25D 11/02

(52) U.S. Cl. 429/33; 205/333

(57) ABSTRACT

A solid electrolyte includes a metal part having a hydrogen permeability and a metal oxide part having a proton conductivity. The metal part and the metal oxide part are formed integrally. A boundary face formed at a boundary between the hydrogen permeable metal part and the solid electrolyte part is restrained, because the hydrogen permeable metal part and the solid electrolyte part are formed integrally. A peel strength between the hydrogen permeable metal part and the solid electrolyte part is increased.

### TECHNICAL FIELD

This invention generally relates to a solid electrolyte having proton conductivity and a method of manufacturing the solid electrolyte.

### BACKGROUND ART

One or more aspects of this invention generally relates to a solid electrolyte having proton conductivity.

In general, a fuel cell is a device that obtains electrical power from fuel, hydrogen and oxygen. Fuel cell systems are being widely developed as an energy supply system because fuel cells are environmentally superior and can achieve high energy efficiency.

In the fuel cell including a solid electrolyte having proton conductivity, some hydrogen provided with an anode is converted into protons, the protons are conducted in the solid electrolyte and reacts with oxygen provided with a cathode. Electrical power is thus generated. This fuel cell has a construction in which a hydrogen permeable metal and the solid electrolyte are deposited.

Japanese Patent Application Publication No. 2004-146337, for example, proposes a method of forming an electrolyte layer on a substrate of dense metal having hydrogen permeability. According to the method, it is possible to reduce the thickness of the electrolyte layer because the metal having hydrogen permeability is dense.

However, by depositing the electrolyte layer on the substrate, the interface strength between the electrolyte layer and the substrate is reduced. It is thus possible that a boundary separation between the electrolyte layer and the substrate occurs.

Various aspects of this invention have been made in view of the above-mentioned circumstances. One or more aspects of the invention provide a solid electrolyte in which a boundary separation between a solid electrolyte layer having proton conductivity and a metal substrate having hydrogen permeability does not occur.

### DISCLOSURE OF THE INVENTION

In exemplary embodiments, a solid electrolyte includes a metal part having hydrogen permeability and a metal oxide part having proton conductivity. The metal part and the metal oxide part are formed integrally.

In exemplary embodiments, a method of manufacturing a solid electrolyte involves providing a hydrogen permeable metal substrate that has a valve metal forming at least a part thereof, and forming subsequently a metal oxide part having proton conductivity by anodizing at least a part of the valve metal.

### EFFECT OF THE INVENTION

In accordance with the invention, a boundary face formed between a metal oxide part and a metal part is restrained. The peel strength between the metal oxide part and the metal part is increased.

### BRIEF DESCRIPTION OF THE DRAWINGS

Exemplary embodiments of one or more aspects of the invention will be described with reference to the following drawings, wherein:

FIG. 1 illustrates a schematic view of an exemplary solid electrolyte in accordance with the first embodiment;

FIGS. 2A-2C illustrate a method of manufacturing a solid electrolyte in accordance with the first embodiment;

FIG. 3 illustrates a schematic view of the solid electrolyte in accordance with the second embodiment;

FIGS. 4A-4D illustrate a method of manufacturing the solid electrolyte in accordance with the second embodiment;

FIG. 5 illustrates a schematic view of the solid electrolyte in accordance with the third embodiment; and

FIGS. 6A-6D illustrate a method of manufacturing the solid electrolyte in accordance with the third embodiment.

### BEST MODE FOR CARRYING OUT THE INVENTION

### First Embodiment

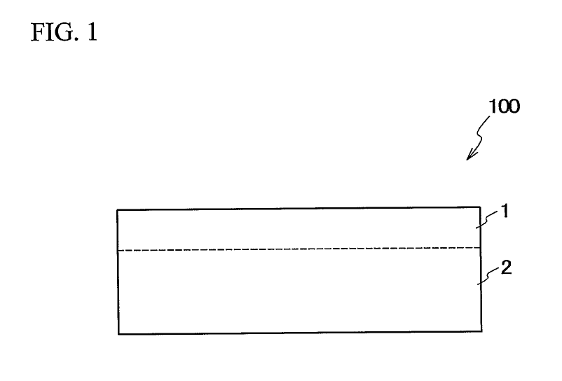

FIG. 1 illustrates a schematic view of a solid electrolyte 100 in accordance with a first embodiment. As shown in FIG. 1, the solid electrolyte 100 may have a construction in which a solid electrolyte part 1 and a hydrogen permeable metal part 2 may be formed integrally. That is, there is no physical interface between the solid electrolyte part 1 and the hydrogen permeable metal part 2. The solid electrolyte part 1 may be formed of a metal oxide having proton conductivity. The hydrogen permeable metal part 2 may be formed of a hydrogen permeable metal. The metal forming the solid electrolyte part 1 may be the same as the metal forming the hydrogen permeable metal part 2. In this embodiment, tantalum oxide can be used for the solid electrolyte part 1 and tantalum can be used for the hydrogen permeable metal part 2.

In the solid electrolyte 100 in accordance with this embodiment, a boundary face formed at an boundary between the solid electrolyte part 1 and the hydrogen permeable metal part 2 is restrained, because the solid electrolyte part 1 and the hydrogen permeable metal part 2 are formed integrally. A peel strength between the solid electrolyte part 1 and the hydrogen permeable metal part 2 is thus increased. In addition, a boundary face formed at a boundary between the solid electrolyte part 1 and the hydrogen permeable metal part 2 is restrained, because the metal forming the solid electrolyte part 1 is the same as the metal forming the hydrogen permeable metal part 2.

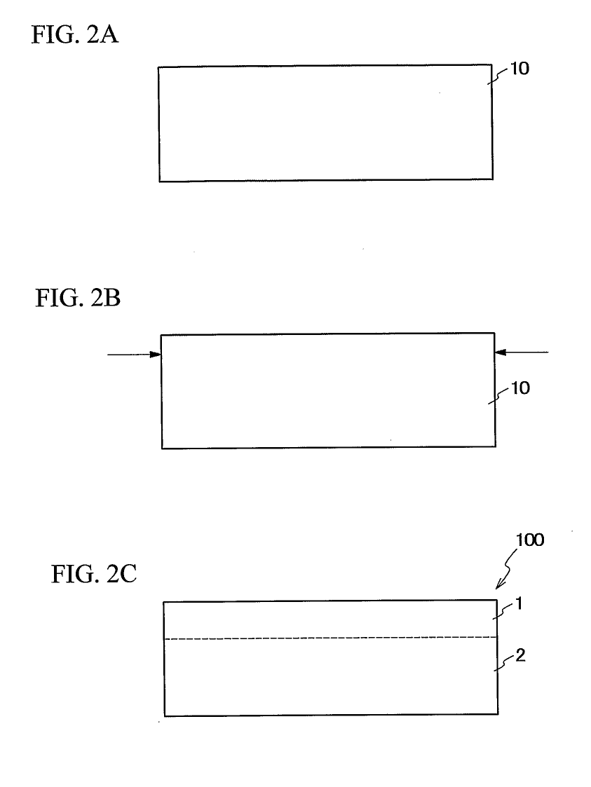

FIGS. 2A-2C illustrate a method of manufacturing the solid electrolyte 100. As shown in FIG. 2A, a hydrogen permeable metal substrate 10 may be provided. The hydrogen permeable metal substrate 10 may be formed of, for example, a hydrogen permeable valve metal like tantalum or the like. As used herein, the valve metal means the metal that can be oxidized by anodization.

Next, as shown in FIG. 2B, an area neighboring one face of the hydrogen permeable metal substrate 10 may be subjected to anodic oxidation treatment. The area may be thus oxidized. The solid electrolyte part 1 may thus be formed neighboring the face of the hydrogen permeable metal substrate 10, as shown in FIG. 2C. In this case, it is possible to oxidize the area neighboring the face of the hydrogen permeable metal substrate 10 by masking a part except for a part to be subjected to the anodic oxidation treatment with a tape. The solid electrolyte 100 may be fabricated through the operations mentioned-above.

In this embodiment, the solid electrolyte part 1 is formed uniformly because the hydrogen permeable metal substrate 10 is oxidized by an anodic oxidation method. In addition, a manufacturing cost of the solid electrolyte 100 is reduced because it is not necessary to generate a vacuum condition in a case of CVD method, PVD method, sputtering method or the like. Further, it is prevented that the boundary separation between the solid electrolyte part 1 and the hydrogen permeable metal part 2 occurs because of the difference between coefficients of thermal expansion of these parts, because it is not necessary to heat the hydrogen permeable metal substrate 10 in the anodic oxidation treatment.

In addition, the solid electrolyte part 1 and the hydrogen permeable metal part 2 are formed integrally because the solid electrolyte part 1 and the hydrogen permeable metal part 2 are formed from the hydrogen permeable metal substrate 10. The boundary face formed at the boundary between the solid electrolyte part 1 and the hydrogen permeable metal part 2 is thus restrained. Accordingly, the peel strength between the solid electrolyte part 1 and the hydrogen permeable metal part 2 is increased. Further, the manufacturing cost of the solid electrolyte 100 is reduced, because a single component metal substrate is just provided as the hydrogen permeable metal substrate 10.

In addition, the hydrogen permeable metal substrate 10 may include another valve metal like zirconium, titanium, aluminum or the like that have lower valence. In this case, an oxygen vacancy is formed in the solid electrolyte part 1, by anodizing the hydrogen permeable metal substrate 10. The proton conductivity of the solid electrolyte part 1 is thus improved.

In this embodiment, the hydrogen permeable metal part 2 corresponds to the metal part, and the solid electrolyte part 1 corresponds to the metal oxide part.

### Second Embodiment

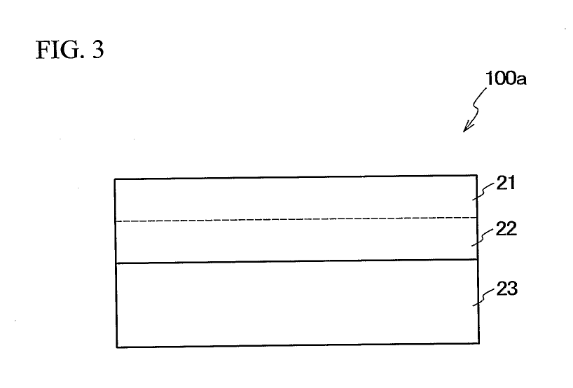

FIG. 3 illustrates a schematic view of a solid electrolyte 100a in accordance with a second embodiment. As shown in FIG. 3, the solid electrolyte 100a may have a construction in which a valve metal part 22 is sandwiched between a solid electrolyte part 21 and a hydrogen permeable metal part 23. The solid electrolyte part 21, the valve metal part 22 and the hydrogen permeable metal part 23 may be formed integrally. The valve metal part 22 may be bonded metallurgically to the hydrogen permeable metal part 23.

The solid electrolyte part 21 may be formed of a metal oxide having proton conductivity. The valve metal part 22 may be formed of a valve metal. The hydrogen permeable metal part 23 may be formed of a hydrogen permeable metal. The metal forming the solid electrolyte part 21 may be the same as the metal forming the valve metal part 22. In this embodiment, tantalum oxide can be used for the solid electrolyte part 21, tantalum can be used for the valve metal part 22, and vanadium or the like can be used for the hydrogen permeable metal part 23.

In the solid electrolyte 100a in accordance with this embodiment, a boundary face formed at a boundary between the solid electrolyte part 21 and the valve metal part 22 is restrained, because the solid electrolyte part 21 and the valve metal part 22 are formed integrally. A peel strength between the solid electrolyte part 21 and the valve metal part 22 is thus increased. In addition, the interface strength between the solid electrolyte part 21 and the valve metal part 22 is increased, because the valve metal part 22 is bonded metallurgically to the hydrogen permeable metal part 23. The peel strength between the valve metal part 22 and the hydrogen permeable metal part 23 is thus increased.

Further, the metal forming the hydrogen permeable metal part 23 may not be a valve metal. The range of choice of materials of the hydrogen permeable metal part 23 is thus broadened. For example, an inexpensive metal like vanadium can be used for the hydrogen permeable metal part 23. The manufacturing cost can thus be reduced.

In addition, vanadium is easily oxidizable, but tantalum has an oxidation resistance. It is thus prevented that the hydrogen permeable metal part 23 is oxidized by an oxygen of the solid electrolyte part 21.

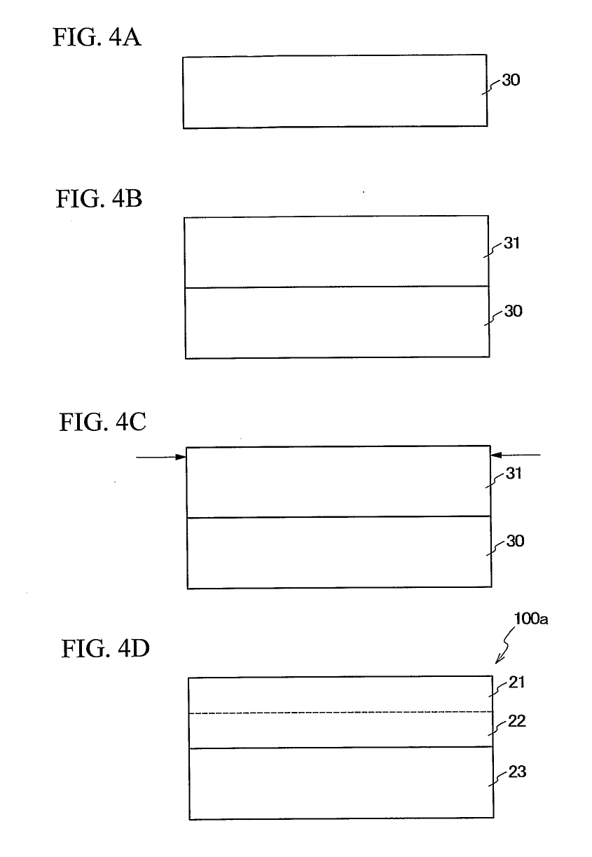

FIGS. 4A-4D illustrate a method of manufacturing the solid electrolyte 100a. As shown in FIG. 4A, a hydrogen permeable metal substrate 30 may be provided. The hydrogen permeable metal substrate 30 may be formed of, for example, a metal like vanadium. Next, as shown in FIG. 4B, a valve metal layer 31 may be formed on one face of the hydrogen permeable metal substrate 30 by a sputtering method or the like. The valve metal layer 31 may be formed of a valve metal like tantalum. Then, as shown in FIG. 4C, an area neighboring one face of the valve metal layer 31 may be subjected to anodic oxidation treatment. The area may be thus oxidized. In this case, it is possible to oxidize the area neighboring the face of the valve metal layer 31 by masking a part except for a part to be subjected to the anodic oxidation treatment with a tape. As shown in FIG. 4D, the solid electrolyte part 21 and the valve metal part 22 may be formed from the valve metal layer 31. The hydrogen permeable metal part 23 may also correspond to the hydrogen permeable metal substrate 30. The solid electrolyte 100a may be fabricated through the operations mentioned-above.

As mentioned above, the valve metal part 22 and the solid electrolyte part 21 are formed uniformly because the valve metal part 22 and the solid electrolyte part are formed from the valve metal layer 31. A boundary face formed at a boundary between the valve metal part 22 and the solid electrolyte part 21 is thus restrained. In addition, the hydrogen permeable metal substrate 30 is bonded metallurgically to the valve metal layer 31, because the valve metal layer 31 is formed on the face of the hydrogen permeable metal substrate 30 by sputtering. The interface strength between the valve metal part 22 and the hydrogen permeable metal part 23 is thus increased.

In addition, the valve metal layer 31 may include another valve metal like zirconium, titanium, aluminum or the like that have lower valence. In this case, an oxygen vacancy is formed in the solid electrolyte part 21, by anodizing the valve metal layer 31. The proton conductivity of the solid electrolyte part 21 is improved.

In this embodiment, the valve metal part 22 corresponds to the metal part, the solid electrolyte part 21 corresponds to the metal oxide part, and the hydrogen permeable metal part 23 corresponds to the second metal part.

### Third Embodiment

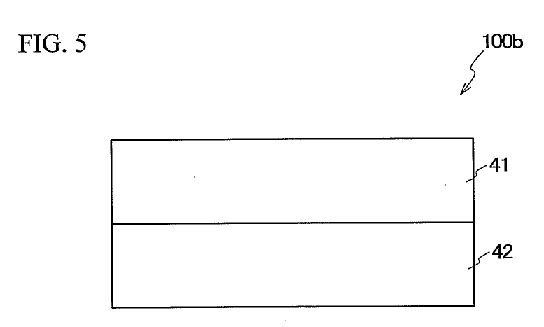

FIG. 5 illustrates a schematic view of a solid electrolyte 199b in accordance with a third embodiment. As shown in FIG. 5, the solid electrolyte 100b may have a construction in which a solid electrolyte part 41 and a hydrogen permeable metal part 42 are formed integrally. The solid electrolyte part 41 may be formed of a metal oxide having proton conductivity. The hydrogen permeable metal part 42 may be formed of a hydrogen permeable metal. The metal forming the solid electrolyte part 41 may be the same as the metal forming the hydrogen permeable metal part 42. In this embodiment, tantalum oxide can be used for the solid electrolyte part 41 and palladium can be used for the hydrogen permeable metal part 42.

In the solid electrolyte 100b in accordance with this embodiment, a peel strength between the solid electrolyte part 41 and the hydrogen permeable metal part 42 is increased, because the solid electrolyte part 41 and the hydrogen permeable metal part 42 are formed integrally.

In addition, palladium can dissociate molecular hydrogen. The hydrogen permeable metal part 42 can also dissociate molecular hydrogen if palladium is used for the hydrogen permeable metal part 42. It is therefore not necessary to provide an anode when a fuel cell is produced. The manufacturing cost of the fuel cell including the solid electrolyte 100b can thus be reduced.

Further, a coefficient of hydrogen swell of tantalum is bigger than that of palladium. In the solid electrolyte 100b in accordance with this embodiment, no tantalum layer is formed between the hydrogen permeable metal part 42 and the solid electrolyte part 41. It is therefore prevented that a crack occurs between the hydrogen permeable metal part 42 and the solid electrolyte part 41.

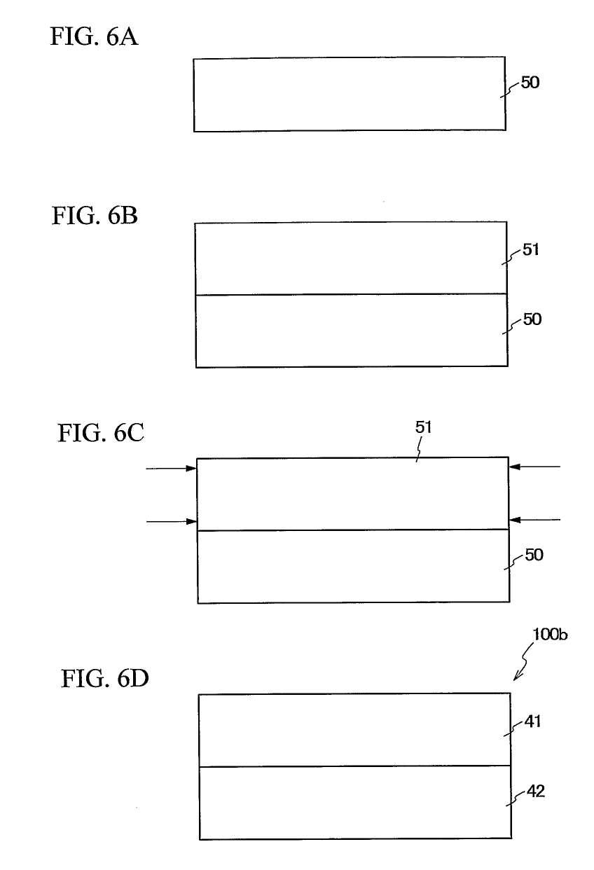

FIGS. 6A-6D illustrate a method of manufacturing the solid electrolyte 100b. As shown in FIG. 6A, a hydrogen permeable metal substrate 50 may be provided. The hydrogen permeable metal substrate 50 may be formed of, for example, a metal like palladium or the like. Next, as shown in FIG. 6B, a valve metal layer 51 may be formed on one face of the hydrogen permeable metal substrate 50 by a sputtering method or the like. The valve metal layer 51 may be formed of a valve metal like tantalum or the like. Then, as shown in FIG. 6C, the whole valve metal layer 51 may be subjected to anodic oxidation treatment, and the all of the valve metal layer 51 may be oxidized anodically. In this case, it is possible to oxidize the whole valve metal layer 51 by masking the hydrogen permeable metal substrate 50 with a tape. As shown in FIG. 6D, the solid electrolyte part 41 may be formed from the valve metal layer 51. The hydrogen permeable metal part 42 may also correspond to the hydrogen permeable metal substrate 50. The solid electrolyte 100b may be fabricated through the operations mentioned-above.

As mentioned above, the hydrogen permeable metal substrate 50 is bonded metallurgically to the valve metal layer 51, because the valve metal layer 51 is formed on the face of the hydrogen permeable metal substrate 50. The interface strength between the solid electrolyte part 41 after anodic oxidation and the hydrogen permeable metal part 42 is thus increased.

In addition, the valve metal layer 51 may include another valve metal like zirconium, titanium, aluminum or the like that have lower valence. In this case, an oxygen vacancy is formed in the solid electrolyte part 41, by anodizing the valve metal layer 51. The proton conductivity of the solid electrolyte part 41 is improved.

In this embodiment, the hydrogen permeable metal part 42 corresponds to the metal part, and the solid electrolyte part 41 corresponds to the metal oxide part.

Throughout the following description, numerous specific concepts and structures are set forth in order to provide a thorough understanding of the invention. The invention can be practiced without utilizing all of these specific concepts and structures. In other instances, well known elements have not been shown or described in detail, so that emphasis can be focused on the invention.

The solid electrolyte according to one or more aspects of the invention may include a metal part having hydrogen permeability and a metal oxide part having proton conductivity. The metal part and the metal oxide part may be formed integrally.

In exemplary embodiments, a boundary face formed at a boundary between the metal oxide part and the metal part is restrained, because the metal oxide part and the metal part are formed integrally. A peel strength between the metal oxide part and the metal part is thus increased.

In exemplary embodiments, the metal part may border on the metal oxide part, and a metal forming the metal part may be the same as a metal forming the metal oxide part. In this case, the boundary face formed at the boundary between the metal oxide part and the metal part is restrained.

In exemplary embodiments, the solid electrolyte may further include a second metal part having hydrogen permeability. The second metal part, the metal part and the metal oxide part may also border in sequence, and a metal forming the metal part may be the same as a metal forming the metal oxide part. In this case, the second metal part is bonded metallurgically to the metal part. An interface strength between the second metal part and the metal part is thus increased. Accordingly, a peel strength between the second metal part and the metal part is increased. In addition, the manufacturing cost is reduced, if an inexpensive metal is used for the second metal part and the thickness of the metal part is reduced. Further, oxidation of the second metal part is restrained because the metal part is provided between the second metal part and the solid electrolyte part.

The method of manufacturing a solid electrolyte according to one or more aspects of the invention may include providing a hydrogen permeable metal substrate that has a valve metal forming at least a part thereof, and forming subsequently a metal oxide part having proton conductivity by anodizing at least a part of the valve metal.

In exemplary embodiments, the metal oxide part and the hydrogen permeable metal substrate are formed integrally. A boundary face formed at a boundary between the metal oxide part and the hydrogen permeable metal substrate is therefore restrained. Accordingly, a peel strength between the metal oxide part and the hydrogen permeable metal substrate is increased.

In exemplary embodiments, the hydrogen permeable metal substrate may include a valve metal having hydrogen permeability. In this case, a metal forming the metal oxide part is the same as a metal forming the hydrogen permeable metal substrate. The boundary face formed at a boundary between the hydrogen permeable metal substrate and the metal oxide part is therefore restrained. In addition, the manufacturing cost of the solid electrolyte in accordance with the present invention is reduced, because a single component metal substrate is just provided as the hydrogen permeable metal substrate.

In exemplary embodiments, providing a hydrogen permeable metal substrate may include forming a valve metal part having hydrogen permeability on one face of the hydrogen permeable metal substrate. In this case, the valve metal part and the metal oxide part are formed integrally. A boundary face formed at a boundary between the valve metal part and the metal oxide part is therefore restrained. Accordingly, a peel strength between the metal oxide part and the valve metal part is increased. In addition, the hydrogen permeable metal substrate is bonded metallurgically to the valve metal part. An interface strength between the valve metal part and the hydrogen permeable metal substrate is thus increased.

In exemplary embodiments, providing a hydrogen permeable metal substrate may include forming a valve metal part having hydrogen permeability on one face of the hydrogen permeable metal substrate, and forming the metal oxide party may include forming a metal oxide part having proton conductivity by anodizing the whole valve metal part. In this case, it is prevented that a crack occurs between the hydrogen permeable metal substrate and the metal oxide part, even if a coefficient of hydrogen expansion of the metal forming the hydrogen permeable metal substrate and that of the metal forming the valve metal.

1. A solid electrolyte comprising:
a metal part having hydrogen permeability; and
a metal oxide part having proton conductivity,
wherein:
the metal part and the metal oxide part are formed integrally;
the metal part borders on the metal oxide part; and a metal forming the metal part is the same as a metal forming the metal oxide part.

2. (canceled)

3. The solid electrolyte as claimed in claim 1, further comprising a second metal part having hydrogen permeability,
wherein the second metal part, the metal part and the metal oxide part border in sequence.

4. A method of manufacturing a solid electrolyte comprising;
providing a hydrogen permeable metal substrate that has a valve metal forming at least a part thereof; and
forming subsequently a metal oxide part having proton conductivity by anodizing at least a part of the valve metal.

5. The method of manufacturing the solid electrolyte as claimed in claim 4, wherein the hydrogen permeable metal substrate includes a valve metal having hydrogen permeability.

6. The method of manufacturing the solid electrolyte as claimed in claim 4, wherein providing the hydrogen permeable metal substrate includes forming a valve metal part having hydrogen permeability on one face of the hydrogen permeable metal substrate.

7. The method of manufacturing the solid electrolyte as claimed in claim 4, wherein:
providing the hydrogen permeable metal substrate includes forming a valve metal part having hydrogen permeability on one face of the hydrogen permeable metal substrate; and
forming the metal oxide part includes forming a metal oxide part having proton conductivity by anodizing the whole valve metal part.
